(19) United States
(12) Patent Application Publication
(10) Pub. No.: US 2026/0056509 A1
(43) Pub. Date: Feb. 26, 2026

(54) IMAGE FORMING APPARATUS

(71) Applicant: FUJIFILM Business Innovation Corp., Tokyo (JP)

(72) Inventors: Teruyo RYUZAKI, Kanagawa (JP); Naoki SAMBE, Kanagawa (JP); Takahiro ABE, Kanagawa (JP)

(73) Assignee: FUJIFILM Business Innovation Corp., Tokyo (JP)

(21) Appl. No.: 19/047,663

(22) Filed: Feb. 7, 2025

(30) Foreign Application Priority Data
Aug. 23, 2024 (JP) 2024-143460

(51) Int. Cl. G03G 21/20; G03G 15/08

(52) U.S. Cl. CPC G03G 21/206; G03G 15/0898; G03G 2221/163; G03G 2221/1645

(57) ABSTRACT

An image forming apparatus includes: a developing section that accommodates a developer; a blowing part that blows air from a lower side with respect to a bottom surface of the developing section toward the bottom surface to blow wind against the bottom surface; and a flow passage that causes the wind blown against the bottom surface to flow in a blowing direction along the bottom surface.

### CROSS-REFERENCE TO RELATED APPLICATIONS

This application is based on and claims priority under 35 USC 119 from Japanese Patent Application No. 2024-143460 filed Aug. 23, 2024.

### BACKGROUND

### (i) Technical Field

The present invention relates to an image forming apparatus.

### (ii) Related Art

JP2014-142471A discloses an image forming apparatus including a developing device, a support member, a door member, an airflow generation unit, a duct, a pair of first wall portions, and a pair of second wall portions. The developing device is provided to be attachable to and detachable from an apparatus main body. Furthermore, the developing device develops an electrostatic image on a surface of an image supporting body with a developer. The support member supports a lower surface of the developing device along a longitudinal direction of the developing device. The door member is a door member of which an opening portion for attaching and detaching the developing device can be opened and closed. The airflow generation unit generates an airflow. The duct guides the airflow generated by the airflow generation unit into the apparatus main body. The pair of first wall portions are provided between the door member and the developing device, and form a first flow passage that is connected to the duct and through which the airflow generated by the airflow generation unit passes. The pair of second wall portions are provided between the support member and the developing device. The pair of second wall portions form a second flow passage that is connected to the first flow passage and through which the airflow generated by the airflow generation unit passes.

### SUMMARY

As the image forming apparatus, an image forming apparatus including a developing section that accommodates a developer and a blowing part is considered. In the image forming apparatus, a configuration in which the blowing part blows air in a blowing direction along a bottom surface from a front side of the developing section to cool the bottom surface and suppress a temperature rise of the developer is considered. In this configuration, it is difficult to increase a wind speed at the bottom surface, and a temperature rise of the bottom surface may not be suppressed.

Aspects of non-limiting embodiments of the present disclosure relate to an image forming apparatus that suppress a temperature rise of a bottom surface compared to a case where a blowing part blows air only in a blowing direction along the bottom surface of a developing section.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: a developing section that accommodates a developer; a blowing part that blows air from a lower side with respect to a bottom surface of the developing section toward the bottom surface to blow wind against the bottom surface; and a flow passage that causes the wind blown against the bottom surface to flow in a blowing direction along the bottom surface.

### BRIEF DESCRIPTION OF THE DRAWINGS

Exemplary embodiment(s) of the present invention will be described in detail based on the following figures, wherein:

FIG. 1 is a schematic view showing an image forming apparatus according to the present exemplary embodiment;

FIG. 2 is a schematic front view showing a developing section and a periphery thereof according to the present exemplary embodiment; and

FIG. 3 is a schematic side view showing the developing section and the periphery thereof according to the present exemplary embodiment.

### DETAILED DESCRIPTION

Hereinafter, an example of an exemplary embodiment of the present invention will be described with reference to the drawings.

### Image Forming Apparatus 10

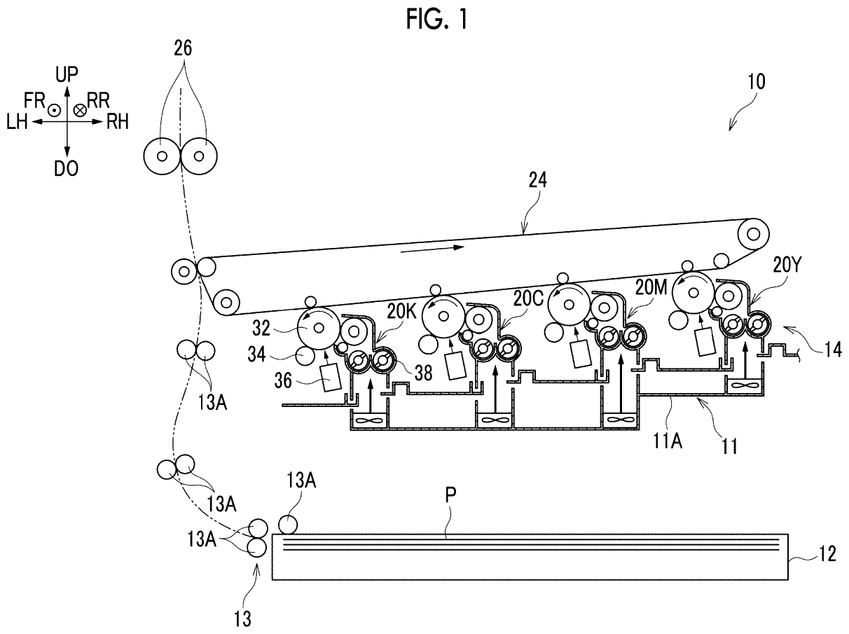

An image forming apparatus 10 according to the present exemplary embodiment will be described. FIG. 1 is a schematic view showing the image forming apparatus 10 according to the present exemplary embodiment.

Note that an arrow UP shown in the drawings represents an upper side (more specifically, an upper side in a vertical direction) of the apparatus, and an arrow DO represents a lower side of the apparatus (specifically, a lower side in the vertical direction). In addition, an arrow LH shown in the drawings represents a left side of the apparatus and an arrow RH represents a right side of the apparatus. Furthermore, an arrow FR shown in the drawings represents a front side of the apparatus and an arrow RR represents a rear side of the apparatus. Since these directions are directions defined for the convenience of description, the configuration of the apparatus is not limited to these directions. The term “apparatus” may be omitted in each direction of the apparatus. That is, for example, “the upper side of the apparatus” may simply be described as “the upper side”.

In addition, in the following description, the term “up-down direction” may be used to mean “both the upper side and the lower side” or “any one of the upper side or the lower side”. The term “right-left direction” may be used to mean “both the right side and the left side” or “any one of the right side or the left side”. The “right-left direction” may also be referred to as a lateral side, a transverse direction, and a horizontal direction. The term “front-rear direction” may be used to mean “both the front side and the rear side” or “any one of the front side or the rear side”. The “front-rear direction” may also be referred to as a lateral side, a transverse direction, and a horizontal direction. In addition, the up-down direction, the right-left direction, and the front-rear direction are directions that intersect each other (specifically, directions orthogonal to each other).

In addition, a symbol in which “×” is written in “○” in the drawings means an arrow pointing from the front to the back of the paper. Furthermore, a symbol in which “•” is written in “○” in the drawings means an arrow pointing from the back to the front of the paper.

The image forming apparatus 10 shown in FIG. 1 is an apparatus that forms an image. Specifically, as shown in FIG. 1, the image forming apparatus 10 includes an image forming apparatus main body 11, a medium accommodation section 12, a transport section 13, and an image forming section 14. Hereinafter, each section of the image forming apparatus 10 will be described.

### Image Forming Apparatus Main Body 11

The image forming apparatus main body 11 shown in FIG. 1 is an example of an apparatus main body. The image forming apparatus main body 11 is a section in which each constituent part of the image forming apparatus 10 is provided. The image forming apparatus main body 11 is configured to include, for example, a frame 11A that forms a framework of the image forming apparatus 10.

### Medium Accommodation Section 12 and Transport Section 13

The medium accommodation section 12 is a section that accommodates a recording medium P in the image forming apparatus 10. The recording medium P accommodated in the medium accommodation section 12 is supplied to the image forming section 14. The recording medium P accommodated in the medium accommodation section 12 is an object on which an image is formed by the image forming section 14. Examples of the recording medium P include a paper sheet and a film. Examples of the film include a resin film and a metal film. Note that the recording medium P is not limited to the media described above, and various recording media can be used.

The transport section 13 shown in FIG. 1 transports the recording medium P stored in the medium accommodation section 12 to a discharge section (not shown). Specifically, as shown in FIG. 1, the transport section 13 includes a plurality of transport members 13A such as transport rolls, and transports the recording medium P by the transport members 13A. Note that the transport member 13A may be, for example, a transport member such as a transport belt and a transport drum and various transport members may also be used.

### Image Forming Section 14

The image forming section 14 shown in FIG. 1 forms an image on the recording medium P transported by the transport section 13 (specifically, the transport member 13A). Specifically, the image forming section 14 forms a toner image (an example of an image) on the recording medium P by an electrophotographic method. More specifically, as shown in FIG. 1, the image forming section 14 includes toner image forming units 20Y, 20M, 20C, and 20K (hereinafter, referred to as 20Y to 20K), a transfer body 24, and a fixing unit 26.

Each of the toner image forming units 20Y to 20K includes a photoreceptor 32. Since the toner image forming units 20Y to 20K have the same configuration, reference numerals for the respective units of the toner image forming units 20Y, 20M, and 20C are omitted in FIG. 1.

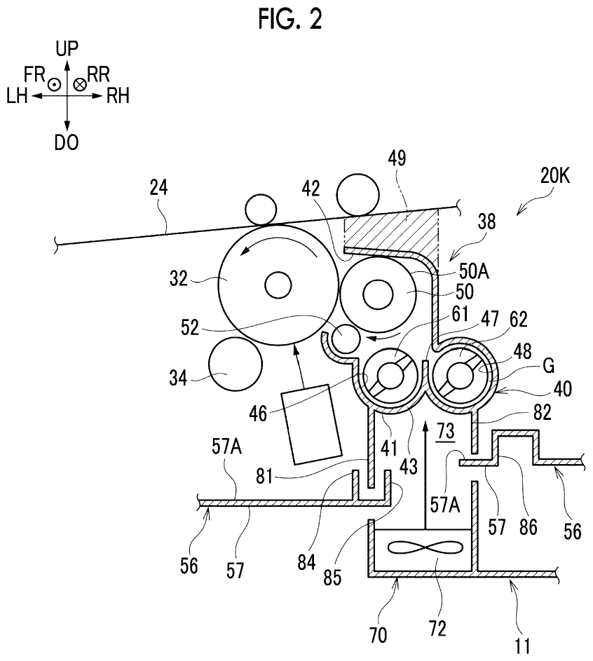

The photoreceptor 32 has a function of holding a latent image. Specifically, the photoreceptor 32 rotates in one direction (for example, a counterclockwise direction in FIGS. 1 and 2). In the vicinity of the photoreceptor 32, a charging device 34, an exposing device 36, and a developing section 38 are provided in this order from an upstream side in a rotation direction of the photoreceptor 32.

In each of the toner image forming units 20Y to 20K, the charging device 34 charges the photoreceptor 32 (a charging step). Furthermore, the exposing device 36 exposes the photoreceptor 32, which is charged by the charging device 34, to form a latent image (specifically, an electrostatic latent image) on the photoreceptor 32 (exposing step). The photoreceptor 32 holds the latent image formed by the exposing device 36.

Then, the developing section 38 develops the latent image held by the photoreceptor 32 (developing step). Accordingly, a toner image is formed on the photoreceptor 32. A specific configuration of the developing section 38 will be described later.

In the image forming section 14, the toner image forming units 20Y to 20K perform the charging step, the exposing step, and the developing step to form toner images of respective colors which are yellow (Y), magenta (M), cyan (C), and black (K) on the transfer body 24. Furthermore, in the image forming section 14, the toner images of the respective colors that are formed on the transfer body 24 are transferred to the recording medium P and the toner images are fixed onto the recording medium P by the fixing unit 26. As described above, the image forming section 14 uses an intermediate transfer method in which an image is transferred to the recording medium P via the transfer body 24.

Note that the image forming section is not limited to the intermediate transfer method, and the image forming section may use a direct transfer method in which an image is directly transferred to the recording medium P. In addition, various image forming sections can also be applied.

### Developing Section 38

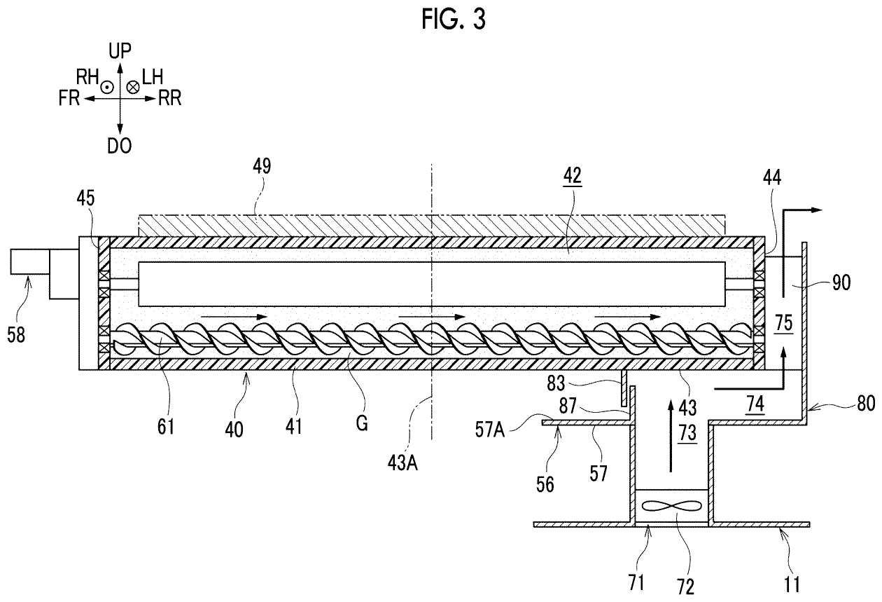

FIG. 2 is a schematic front view showing the developing section and a periphery thereof according to the present exemplary embodiment. FIG. 3 is a schematic side view showing the developing section and the periphery thereof according to the present exemplary embodiment.

As described above, the developing section 38 shown in FIGS. 2 and 3 is a device that develops the latent image held by the photoreceptor 32 with a developer G. The developer G is a developer that includes toner and a magnetic carrier. Specifically, as shown in FIG. 2, the developing section 38 includes a housing 40, a developing roll 50, a layer restricting member 52, and a drive mechanism 90.

The housing 40 is formed by a plurality of wall portions including a bottom wall 41, a front wall 45, and a rear wall 44. The housing 40 accommodates the developer G therein. An opening 42 that is open toward a photoreceptor 32 side (left side in FIG. 2) is formed in the housing 40.

The developing roll 50 has an outer peripheral surface 50A of which a part is exposed through the opening 42. The developing roll 50 rotates while holding the developer G on the outer peripheral surface 50A. The developing roll 50 is an example of a developing body.

The layer restricting member 52 restricts a thickness of a layer of the developer G (the amount of the developer) held by the developing roll 50. The layer restricting member 52 is provided on a lower side of the developing roll 50.

Inside the housing 40, transport paths 46 and 48 for transporting the developer G are provided. The transport path 46 is disposed on the lower side of the developing roll 50 along the front-rear direction.

The transport path 48 is disposed along the transport path 46 to be adjacent to the transport path 46. Specifically, the transport path 48 is disposed on a right side of the transport path 46 along the front-rear direction. A front end portion and a rear end portion of the transport path 48 are respectively connected to a front end portion and a rear end portion of the transport path 46. As a result, the transport paths 46 and 48 form a circulation path. The transport path 46 and the transport path 48 are separated by a partition wall 47 at an intermediate part therebetween in the front-rear direction.

Transport members 61 and 62 are disposed in the transport paths 46 and 48 along the front-rear direction. The developer G accommodated in the transport path 46 is transported in a transport direction (specifically, one side of the front-rear direction) while being agitated by the rotation of the transport member 61. The developer G accommodated in the transport path 48 is transported in the opposite direction (specifically, the other side of the front-rear direction) while being agitated by the rotation of the transport member 62.

The drive mechanism 90 is provided on a rear side of the rear wall 44 of the housing 40. The drive mechanism 90 is a mechanism that drives the transport members 61 and 62. The drive mechanism 90 has a transmission unit (not shown) such as a gear that transmits a driving force for rotating the transport members 61 and 62 to the transport members 61 and 62. The drive mechanism 90 may have a drive unit (not shown) such as a drive motor that generates a driving force for rotating the transport members 61 and 62.

In the developing section 38, the developing roll 50 holds the developer G that has been transported through the transport path 46 on the outer peripheral surface 50A and transports the developer G to a facing position facing the photoreceptor 32. Regarding the developer G that has been transported toward the facing position, the layer restricting member 52 restricts a thickness of a layer of the developer G (the amount of the developer). Then, the developer G (specifically, toner) held on the outer peripheral surface 50A of the developing roll 50 is supplied from the developing roll 50 to the photoreceptor 32 at the facing position. As a result, the electrostatic latent image formed on the photoreceptor 32 is developed by the developer G (specifically, toner). The photoreceptor 32 is an example of a supply target.

In the developing section 38, the developer G (specifically, toner) may scatter from the opening 42 of the housing 40. In addition, the developer G that scatters from the opening 42 and floats may stay above the housing 40. Therefore, in the developing section 38, a retention region 49 in which the floating developer G stays may be generated above the housing 40. The retention region 49 is generated, for example, above the housing 40 and below the transfer body 24 as shown in FIG. 2.

### Pulling-Out of Developing Section 38

The developing section 38 is provided in the image forming apparatus main body 11 so as to be capable of being pulled out to a front side. The image forming apparatus main body 11 is provided with a rail 56 that guides the developing section 38, which is pulled out to the front side, to the front side.

The rail 56 is disposed on the lower side with respect to the housing 40. The rail 56 extends along the front-rear direction. The rail 56 is an example of a guide portion. The rail 56 constitutes a part of a duct 80, which will be described below.

As shown in FIG. 3, an operating part 58 is provided at a front end portion of the developing section 38. Specifically, the operating part 58 is disposed on an outer surface of the front wall 45 of the housing 40. The front end portion is an example of an upstream end portion in a blowing direction.

The operating part 58 is a constituent part that performs a pulling operation of the developing section 38 in a case where the developing section 38 is pulled out to the front side. That is, in a case where an operator pulls out the developing section 38, the operator grabs the operating part 58 and pulls the developing section 38 toward the front side.

The operating part 58 may be configured as an operating part that performs an operation of retracting the developing section 38 in a direction away from the photoreceptor 32 (for example, to the right side). In this case, the developing section 38 may not be configured to be pulled out. In the present exemplary embodiment, the toner image forming units 20Y to 20K including the developing section 38 are disposed such that the front side is a side on which various operations are performed by the operator. The operator includes a user who uses the image forming apparatus 10 and service personnel who performs maintenance, inspection, and repair on the image forming apparatus 10.

### Blowing Mechanism 70

A blower mechanism 70 shown in FIGS. 2 and 3 is a mechanism that blows air to the developing section 38. The blowing mechanism 70 includes a blower 72, a first flow passage 73, a second flow passage 74, a third flow passage 75, and the duct 80.

The blower 72 is an example of a blowing part. The blower 72 blows air from a lower side with respect to a bottom surface 43 of the developing section 38 toward the bottom surface 43 to blow wind against the bottom surface 43. In the present exemplary embodiment, the blower 72 is disposed on a lower side and a rear side with respect to the bottom surface 43 as shown in FIG. 3. The blower 72 blows wind against a part (specifically, a portion on the rear side) of the bottom surface 43.

The portion on the rear side (that is, a position where wind is blown) is a portion on the rear side with respect to a center 43A in the front-rear direction of the bottom surface 43 of the developing section 38. More specifically, the portion on the rear side is a portion on the rearmost side in a case where the bottom surface 43 is divided into three equal parts in the front-rear direction. Therefore, in the present exemplary embodiment, the operating part 58 is provided on the front side with respect to the position on the bottom surface 43 where the wind from the blower 72 is blown.

As the blower 72, for example, an axial flow blower that blows air in an axial direction is used. Note that, as the blower 72, a centrifugal blower that blows air in a centrifugal direction, such as a multi-blade blower (for example, a sirocco fan) may be used. As the blower 72, a device capable of blowing wind can be used.

The first flow passage 73 is a flow passage that causes the wind from the blower 72 to flow from the lower side with respect to the bottom surface 43 toward the bottom surface 43. The second flow passage 74 is a flow passage that causes the wind that has been blown against the bottom surface 43 to flow rearward along the bottom surface 43. The third flow passage 75 is a flow passage that causes the wind has flowed through the second flow passage 74 to flow upward on the rear side with respect to the opening 42.

The third flow passage 75 is disposed on the rear side with respect to the retention region 49. That is, the third flow passage 75 is a flow passage that causes the wind that has flowed through the second flow passage 74 to flow upward on the rear side with respect to the retention region 49. The third flow passage 75 causes the wind that has flowed through the second flow passage 74 to flow upward at a position overlapping with the drive mechanism 90 in the front-rear direction.

The wind from the blower 72 flows through the first flow passage 73, the second flow passage 74, and the third flow passage 75 in this order. That is, the first flow passage 73, the second flow passage 74, and the third flow passage 75 are disposed in this order from an upstream side.

The first flow passage 73 is an example of an upstream side flow passage. The second flow passage 74 is an example of a flow passage. The third flow passage 75 is an example of a downstream side flow passage. A rearward direction is an example of a blowing direction along the bottom surface. The rearward direction is also an example of a downstream side in the blowing direction. A forward direction is an example of the upstream side in the blowing direction. An upward direction is an example of an intersecting direction intersecting the blowing direction. The blowing direction in the present exemplary embodiment is a longitudinal direction and an axial direction of the developing section 38 and the components (for example, the developing roll 50 and the transport members 61 and 62). In addition, the blowing direction is also the transport direction in which the developer G is transported in the transport paths 46 and 48.

The first flow passage 73, the second flow passage 74, and the third flow passage 75 are formed inside the duct 80. That is, the duct 80 is a member (specifically, a pipe) that forms the first flow passage 73, the second flow passage 74, and the third flow passage 75.

The duct 80 includes the above-described housing 40 and the above-described rail 56. The rail 56 forms the first flow passage 73 and the second flow passage 74. The housing 40 forms the second flow passage 74 and the third flow passage 75.

Furthermore, the duct 80 has protruding portions 81, 82, 83, 84, 85, 86, and 87 as shown in FIGS. 2 and 3. The protruding portions 81, 82, and 83 protrude downward from the bottom surface 43 of the housing 40 toward the rail 56. The protruding portions 81 and 82 extend in the front-rear direction along the bottom surface 43. The protruding portions 81 and 82 are formed in a plate shape with a thickness direction being the right-left direction. The protruding portions 81 and 82 are examples of a lower protruding portion.

The protruding portion 83 extends in the right-left direction along the bottom surface 43. The protruding portion 83 is formed in a plate shape with a thickness direction being the front-rear direction. The protruding portion 83 is an example of a second upstream protruding portion.

The protruding portions 84, 85, 86, and 87 are provided on the rail 56. The protruding portions 84, 85, 86, and 87 protrude upward from a rail main body 57. The rail main body 57 is a portion that forms a main body of the rail 56. The rail main body 57 is formed, for example, in a plate shape with a thickness direction being the up-down direction. The protruding portions 84, 85, and 86 extend in the front-rear direction along an upper surface 57A of the rail main body 57. The protruding portions 84, 85, and 86 are formed in a plate shape with a thickness direction being the right-left direction.

The protruding portions 84 and 85 protrude upward on both sides of the protruding portion 81 in the right-left direction and face the protruding portion 81 on both sides. In the present exemplary embodiment, the protruding portions 84 and 85 and the rail main body 57 form a U-shape that is open upward. A lower end portion of the protruding portion 81 is inserted into the opening.

The protruding portions 84, 85, and 81 constitute left walls of the first flow passage 73 and the second flow passage 74. In other words, the protruding portions 84, 85, and 81 form the first flow passage 73 and the second flow passage 74. A gap is provided between the protruding portion 84 and the protruding portion 81. A gap is provided between the protruding portion 85 and the protruding portion 81. In a case where the developing section 38 is pulled out, the protruding portion 81 is guided to the protruding portions 84 and 85.

The right-left direction is an example of a width direction intersecting the blowing direction and the up-down direction. The protruding portions 84 and 85 are examples of an upper protruding portion.

The protruding portion 86 is disposed on the right side with respect to the protruding portion 82. The protruding portion 86 faces the protruding portion 82. The protruding portions 86 and 82 constitute right walls of the first flow passage 73 and the second flow passage 74. In other words, the protruding portions 86 and 82 form the first flow passage 73 and the second flow passage 74. A gap is provided between the protruding portion 86 and the protruding portion 82. In a case where the developing section 38 is pulled out, the protruding portion 82 is guided to the protruding portion 86.

The protruding portion 87 protrudes upward on the front side with respect to a position in the developing section 38 where the wind from the blower 72 is blown. The protruding portion 83 protrudes downward from the bottom surface 43 toward the protruding portion 87 on the front side with respect to the protruding portion 87. The protruding portions 87 and 83 constitute front walls of the first flow passage 73 and the second flow passage 74. In other words, the protruding portions 87 and 83 form the first flow passage 73 and the second flow passage 74. A gap is provided between the protruding portion 87 and the protruding portion 83. In a case where the developing section 38 is pulled out, the protruding portion 83 moves forward away from the protruding portion 87 side.

The protruding portion 87 is an example of an upstream protruding portion and a first upstream protruding portion. The protruding portion 83 is an example of the second upstream protruding portion.

### Action According to Present Exemplary Embodiment

According to the present exemplary embodiment, the blower 72 blows air from the lower side with respect to the bottom surface 43 of the developing section 38 toward the bottom surface 43 to blow wind against the bottom surface 43. As described above, by blowing the wind against the bottom surface 43, it is possible to increase a wind speed of the wind in contact with the bottom surface 43, compared to a case where the wind flows along the bottom surface 43. Therefore, a temperature rise of the bottom surface 43 is suppressed compared to a case where the blower 72 blows air only in the blowing direction along the bottom surface 43 of the developing section 38. As a result, a temperature rise of the developer G accommodated in the housing 40 is suppressed.

In the present exemplary embodiment, the blower 72 blows wind against a part of the bottom surface 43. Therefore, an increase in size of the blower 72 is suppressed compared to a case where the blower 72 blows air against the entire bottom surface 43 in the front-rear direction.

In the present exemplary embodiment, the operating part 58 is provided on the front side with respect to the position on the bottom surface 43 where the wind from the blower 72 is blown. Therefore, compared to case where the operating part 58 is provided on the rear side with respect to the position on the bottom surface 43 where the wind from the blower 72 is blown, the wind is less likely to flow to the operating part 58 and foreign matter is less likely to adhere to the operating part 58. As a result, contamination of the operating part 58 is suppressed.

In the present exemplary embodiment, the blower 72 blows wind against the portion on the rear side of the bottom surface 43. Therefore, compared to a case where the blower 72 blows wind to a portion on the front side of the bottom surface 43, an increase in length of the second flow passage 74 in the front-rear direction is suppressed. In addition, compared to a case where the blower 72 blows wind against the portion on the front side of the bottom surface 43, the wind is less likely to flow to the operating part 58 and foreign matter is less likely to adhere to the operating part 58. As a result, contamination of the operating part 58 is suppressed.

In the present exemplary embodiment, the rail 56 forms the first flow passage 73 that causes the wind from the blower 72 to flow from the lower side with respect to the bottom surface 43 toward the bottom surface 43. Therefore, the number of components of the image forming apparatus 10 is reduced compared to a case where a constituent part separate from the rail 56 forms the first flow passage 73.

In the present exemplary embodiment, the protruding portions 81 and 82 and the rail 56 (specifically, the protruding portions 84, 85, and 86) form the first flow passage 73. Therefore, the wind is less likely to escape from the bottom surface 43 than in a case where the first flow passage 73 is formed only by the rail 56. As a result, the escaping wind is suppressed from flowing into the opening 42 and the retention region 49 and scattering the toner.

In the present exemplary embodiment, the protruding portions 84 and 85 protrude upward on both sides of the protruding portion 81 in the right-left direction and face the protruding portion 81 on both sides. Therefore, the wind is less likely to escape from the bottom surface 43 than in a case where any one of the protruding portion 84 or 85 faces the protruding portion 81 on one side in the right-left direction. As a result, the escaping wind is suppressed from flowing into the opening 42 and the retention region 49 and scattering the toner.

In the present exemplary embodiment, the rail 56 has the protruding portion 87 that protrudes upward on the front side with respect to the position in the developing section 38 where the wind from the blower 72 is blown. Therefore, the wind that has been blown against the bottom surface 43 is suppressed from flowing to the front side, compared to a case where the rail 56 has only the protruding portion 84.

In the present exemplary embodiment, the protruding portion 83 and the protruding portion 87 form the first flow passage 73. Therefore, the wind is less likely to escape from the bottom surface 43 than in a case where the first flow passage 73 is formed only by the protruding portion 87. As a result, the escaping wind is suppressed from flowing into the opening 42 and the retention region 49 and scattering the toner.

In the present exemplary embodiment, the third flow passage 75 causes the wind that has flowed through the second flow passage 74 to flow upward on the rear side with respect to the opening 42. Therefore, compared to a case where the third flow passage 75 causes the wind that has flowed through the second flow passage 74 to flow upward at a position overlapping with the opening 42 in the front-rear direction, contamination inside the image forming apparatus 10 caused by the developer G that has flowed out through the opening 42 is suppressed.

In the present exemplary embodiment, the third flow passage 75 causes the wind that has flowed through the second flow passage 74 to flow upward on the rear side with respect to the retention region 49. Therefore, compared to a case where the third flow passage 75 causes the wind that has flowed through the second flow passage 74 to flow upward at a position overlapping with the retention region 49 in the front-rear direction, contamination inside the image forming apparatus 10 caused by the developer G that stays in the retention region 49 is suppressed.

### Modification Examples

In the present exemplary embodiment, the second flow passage 74 causes the wind to flow to the rear side, but the second flow passage 74 is not limited thereto. For example, the second flow passage 74 may cause the wind to flow in any one of a forward direction, a leftward direction, a rightward direction, a front-right oblique direction, a rear-right oblique direction, a front-left oblique direction, or a rear-left oblique direction. Therefore, the blowing direction can be set to, for example, a direction such as a forward direction, a leftward direction, a rightward direction, a front-right oblique direction, a rear-right oblique direction, a front-left oblique direction, or a rear-left oblique direction. An example of the width direction intersecting the blowing direction and the up-down direction can be set to, for example, a direction such as the right-left direction, the front-rear direction, a front-right oblique direction, a rear-right oblique direction, a front-left oblique direction, or a rear-left oblique direction depending on the blowing direction. In addition, an example of the intersecting direction intersecting the blowing direction can be set to, for example, a direction such as the up-down direction, the right-left direction, the front-rear direction, a front-right oblique direction, a rear-right oblique direction, a front-left oblique direction, or a rear-left oblique direction depending on the blowing direction.

In the present exemplary embodiment, the blower 72 blows the wind against a part of the bottom surface 43, but the blower 72 is not limited thereto. For example, the blower 72 may be configured to blow wind against the entire bottom surface 43 in the front-rear direction.

In the present exemplary embodiment, the blower 72 blows wind against the portion on the rear side of the bottom surface 43, but the blower 72 is not limited thereto. For example, the blower 72 may be configured to blow wind against the portion on the front side of the bottom surface 43.

In the present exemplary embodiment, the operating part 58 is provided on the front side with respect to the position on the bottom surface 43 where the wind from the blower 72 is blown, but the operating part 58 is not limited thereto. For example, the operating part 58 may be configured to be provided on the rear side with respect to the position on the bottom surface 43 where the wind from the blower 72 is blown.

In the present exemplary embodiment, the rail 56 forms the first flow passage 73 that causes the wind from the blower 72 to flow from the lower side with respect to the bottom surface 43 toward the bottom surface 43, but the rail 56 is not limited thereto. For example, a configuration in which a constituent part separate from the rail 56 forms the first flow passage 73 may be adopted.

In the present exemplary embodiment, the protruding portions 81 and 82 and the rail 56 (specifically, the protruding portions 84, 85, and 86) form the first flow passage 73, but the protruding portions 81 and 82 and the rail 56 are not limited thereto. For example, a configuration in which the first flow passage 73 is formed only by the rail 56 may be adopted.

In the present exemplary embodiment, the protruding portions 84 and 85 protrude upward on both sides of the protruding portion 81 in the right-left direction and face the protruding portion 81 on both sides, but the protruding portions 84 and 85 are not limited thereto. For example, any one of the protruding portion 84 or 85 may be configured to face the protruding portion 81 on one side in the right-left direction.

In the present exemplary embodiment, the rail 56 has the protruding portion 87 that protrudes upward on the front side with respect to the position in the developing section 38 where the wind from the blower 72 is blown, but the rail 56 is not limited thereto.

The Rail 56 may be configured to have only the protruding portion 84.

In the present exemplary embodiment, the protruding portion 83 and the protruding portion 87 form the first flow passage 73, but the protruding portion 83 and the protruding portion 87 are not limited thereto. For example, a configuration in which the first flow passage 73 is formed only by the protruding portion 87 may be adopted.

In the present exemplary embodiment, the third flow passage 75 causes the wind that has flowed through the second flow passage 74 to flow upward on the rear side with respect to the opening 42, but the third flow passage 75 is not limited thereto. For example, the third flow passage 75 may be configured to cause the wind that has flowed through the second flow passage 74 to flow upward at the position overlapping with the opening 42 in the front-rear direction.

In the present exemplary embodiment, the third flow passage 75 causes the wind that has flowed through the second flow passage 74 to flow upward on the rear side with respect to the retention region 49, but the third flow passage 75 is not limited thereto. For example, the third flow passage 75 may be configured to cause the wind that has flowed through the second flow passage 74 to flow upward at the position overlapping with the retention region 49 in the front-rear direction.

The present invention is not limited to the above-mentioned exemplary embodiment, and various modifications, changes, and improvements can be made without departing from the scope of the present invention. For example, the above-described modification examples may be configured by combining a plurality of the modification examples as appropriate.

### Supplementary Notes

(((1)))

An image forming apparatus comprising:
a developing section that accommodates a developer;
a blowing part that blows air from a lower side with respect to a bottom surface of the developing section toward the bottom surface to blow wind against the bottom surface; and
a flow passage that causes the wind blown against the bottom surface to flow in a blowing direction along the bottom surface.
   (((2)))

The image forming apparatus according to (((1))),
wherein the blowing part blows wind against a part of the bottom surface in the blowing direction.
   (((3)))

The image forming apparatus according to (((2))),
wherein the blowing part blows wind against a portion of the bottom surface on a downstream side in the blowing direction.
   (((4)))

The image forming apparatus according to any one of (((1))) to (((3))),
wherein an operating part operated by an operator is provided on an upstream side in the blowing direction with respect to a position on the bottom surface where the wind from the blowing part is blown.
   (((5)))

The image forming apparatus according to (((4))),
wherein the operating part is provided at an upstream end portion of the developing section in the blowing direction, and
the blowing part blows wind against a portion of the bottom surface on a downstream side in the blowing direction.
   (((6)))

The image forming apparatus according to any one of (((1))) to (((5))),
wherein the developing section is provided in an apparatus main body so as to be capable of being pulled out to an upstream side in the blowing direction,
the apparatus main body is provided with a guide portion that guides the developing section pulled out to the upstream side in the blowing direction to the upstream side, and
the guide portion forms an upstream side flow passage that causes the wind from the blowing part to flow from the lower side with respect to the bottom surface toward the bottom surface.
   (((7)))

The image forming apparatus according to (((6))),
wherein the developing section has a lower protruding portion that protrudes downward from the bottom surface toward the guide portion, and
the lower protruding portion and the guide portion form the upstream side flow passage.
   (((8)))

The image forming apparatus according to (((7))),
wherein the guide portion has upper protruding portions that protrude upward on both sides of the lower protruding portion in a width direction intersecting the blowing direction and an up-down direction, that face the lower protruding portion on both sides in the width direction, and that form the upstream side flow passage.
   (((9)))

The image forming apparatus according to any one of (((1))) to (((8))),
wherein the guide portion has an upstream protruding portion that protrudes upward on an upstream side in the blowing direction with respect to a position in the developing section where the wind from the blowing part is blown and that forms the upstream side flow passage.
   (((10)))

The image forming apparatus according to (((9))),
wherein the developing section is provided with a second upstream protruding portion that protrudes downward from the bottom surface toward the guide portion on the upstream side in the blowing direction with respect to a first upstream protruding portion as the upstream protruding portion, and
the second upstream protruding portion and the first upstream protruding portion form the upstream side flow passage.
   (((11)))

The image forming apparatus according to any one of (((1))) to (((10))), further comprising:
a developing body that has an outer peripheral surface of which a part is exposed through an opening formed in the developing section and in which the developer is held on the outer peripheral surface;
a supply target to which the developer held on the outer peripheral surface is supplied from the developing body; and
a downstream side flow passage that causes wind that has flowed through the flow passage to flow in an intersecting direction intersecting the blowing direction on a downstream side in the blowing direction with respect to the opening.
   (((12)))

The image forming apparatus according to (((11))),
wherein the downstream side flow passage causes the wind that has flowed through the flow passage to flow in the intersecting direction on a downstream side in the blowing direction with respect to a retention region in which a developer that has been discharged from the opening and floats stays.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a developing section that accommodates a developer;
a blowing part that blows air from a lower side with respect to a bottom surface of the developing section toward the bottom surface to blow wind against the bottom surface; and
a flow passage that causes the wind blown against the bottom surface to flow in a blowing direction along the bottom surface.

2. The image forming apparatus according to claim 1,
wherein the blowing part blows wind against a part of the bottom surface in the blowing direction.

3. The image forming apparatus according to claim 2,
wherein the blowing part blows wind against a portion of the bottom surface on a downstream side in the blowing direction.

4. The image forming apparatus according to claim 1,
wherein an operating part operated by an operator is provided on an upstream side in the blowing direction with respect to a position on the bottom surface where the wind from the blowing part is blown.

5. The image forming apparatus according to claim 4,
wherein the operating part is provided at an upstream end portion of the developing section in the blowing direction, and
the blowing part blows wind against a portion of the bottom surface on a downstream side in the blowing direction.

6. The image forming apparatus according to claim 1,
wherein the developing section is provided in an apparatus main body so as to be capable of being pulled out to an upstream side in the blowing direction,
the apparatus main body is provided with a guide portion that guides the developing section pulled out to the upstream side in the blowing direction to the upstream side, and
the guide portion forms an upstream side flow passage that causes the wind from the blowing part to flow from the lower side with respect to the bottom surface toward the bottom surface.

7. The image forming apparatus according to claim 6,
wherein the developing section has a lower protruding portion that protrudes downward from the bottom surface toward the guide portion, and
the lower protruding portion and the guide portion form the upstream side flow passage.

8. The image forming apparatus according to claim 7,
wherein the guide portion has upper protruding portions that protrude upward on both sides of the lower protruding portion in a width direction intersecting the blowing direction and an up-down direction, that face the lower protruding portion on both sides in the width direction, and that form the upstream side flow passage.

9. The image forming apparatus according to claim 6,
wherein the guide portion has an upstream protruding portion that protrudes upward on an upstream side in the blowing direction with respect to a position in the developing section where the wind from the blowing part is blown and that forms the upstream side flow passage.

10. The image forming apparatus according to claim 9,
wherein the developing section is provided with a second upstream protruding portion that protrudes downward from the bottom surface toward the guide portion on the upstream side in the blowing direction with respect to a first upstream protruding portion as the upstream protruding portion, and
the second upstream protruding portion and the first upstream protruding portion form the upstream side flow passage.

11. The image forming apparatus according to claim 1, further comprising:
a developing body that has an outer peripheral surface of which a part is exposed through an opening formed in the developing section and in which the developer is held on the outer peripheral surface;
a supply target to which the developer held on the outer peripheral surface is supplied from the developing body; and
a downstream side flow passage that causes wind that has flowed through the flow passage to flow in an intersecting direction intersecting the blowing direction on a downstream side in the blowing direction with respect to the opening.

12. The image forming apparatus according to claim 11,
wherein the downstream side flow passage causes the wind that has flowed through the flow passage to flow in the intersecting direction on a downstream side in the blowing direction with respect to a retention region in which a developer that has been discharged from the opening and floats stays.
